(19) United States
(12) Patent Application Publication
(10) Pub. No.: US 2014/0049496 A1
(43) Pub. Date: Feb. 20, 2014

(54) ELECTRONIC DEVICE AND METHOD OF ASSEMBLY FOR SAME

(71) Applicant: OpenPeak Inc., Boca Raton, FL (US)

(72) Inventor: Daniel Szalkowski, Dacula, GA (US)

(21) Appl. No.: 13/970,748

(22) Filed: Aug. 20, 2013

Related U.S. Application Data
(60) Provisional application No. 61/684,850, filed on Aug. 20, 2012.

(51) Int. Cl. G06F 3/041

(52) U.S. Cl. CPC G06F 3/041
USPC 345/173; 29/592.1

(57) ABSTRACT

An electronic device is described herein. The device can include a frame that has a perimeter and can include a display module that may be configured to display images. The device may also have a sensor that may be configured to detect touches from one or more objects in relation to the images displayed by the display module. In addition, the device can have a cover that may sit over the sensor and the display module and can be in contact with at least a portion of the frame. In one arrangement, the perimeter of the frame can be configured to force at least a portion of the cover into a convex position with respect to the display module.

### CROSS-REFERENCE TO RELATED APPLICATIONS

This patent application claims priority to U.S. Patent Application No. 61/684,850, filed on Aug. 20, 2012, which is incorporated herein by reference in its entirety.

### FIELD OF TECHNOLOGY

The present subject matter relates to display modules, such as those used in portable electronic devices, and methods of manufacturing them.

### BACKGROUND

The vast majority of portable electronic devices contain displays for displaying images for a user. In fact, many of these displays include touch screens, which makes the display the primary mechanism of the portable device for entering data or making selections. Because these displays have become such important components of portable devices, the displays have correspondingly increased in size. For example, for many portable devices, the display takes up most of the surface facing the user.

While the size of the displays is a significant concern, there is a competing factor in the design of portable devices: the effort to keep them as thin as possible. To keep the profile of a portable device at a minimum, some manufacturers have attempted to use thinner glass covers for their displays. While this helps make the devices thinner, there is a major disadvantage, especially in relation to touch screens. In particular, the thinner glass is typically bonded to a touch sensor and causes the touch sensor to sag towards or be positioned closer to the liquid crystal display (LCD) module. The LCD module, unfortunately, emits a significant amount of noise, which interferes with the operation of the touch sensor. Prior attempts to reduce this interference have focused on the implementation of filtering software for the touch screen; however, this solution has proven to be ineffective.

### SUMMARY

An electronic device is described herein. The device can include a frame that has a perimeter and can also include a display module that may be configured to display images. The device can also have a sensor that is configured to detect touches from one or more objects in relation to the images displayed by the display module and a cover that may sit over the sensor and the display module and can be in contact with at least a portion of the frame. The perimeter of the frame may be configured to force at least a portion of the cover into a convex position with respect to the display module.

As an example, the perimeter of the frame may include one or more mounting surfaces, and the mounting surfaces may each contain a gradient. In one particular example, the mounting surfaces may each have two end sections and a middle section, and the gradient can increase from the end sections towards the middle section. The gradient may be a substantially smooth curved or angled surface.

The electronic device may further include a securing agent positioned on the mounting surfaces for securing the cover to the frame. For example, the securing agent may be positioned over the gradients of the mounting surfaces. In one arrangement, the cover and the sensor may be integrated into a single unit or can be separate parts secured to one another with a second securing agent.

In another arrangement, the perimeter of the frame may also force at least a portion of the sensor into a convex position with respect to the display module. As an example, the convex positioning of the sensor may substantially track the convex positioning of the cover. In one embodiment, the display module may not be in contact with the frame, and the electronic device may further include another securing agent that secures the display module to the sensor.

Another electronic device is described herein. The device may include a frame that has a perimeter and can include a display module that is configured to display images. The device can also include a sensor that is configured to detect touches from one or more objects in relation to the images displayed by the display module and a cover that sits over the sensor and the display module. The perimeter of the frame may be configured to force at least a portion of the cover and the sensor into a convex position with respect to the display module.

As an example, the perimeter may include a plurality of mounting surfaces, and each mounting surface can include a gradient. As another example, the gradient may be a curved surface that corresponds to the convex position of the cover and the sensor. The cover and the sensor may be integrated into a single unit or can be separate parts secured to one another with a securing agent. The electronic device can further include another securing agent in which the other securing agent can be positioned on each of the mounting surfaces and can secure the cover to the perimeter of the frame.

Another electronic device is described herein. This device can include a frame that has a perimeter with a plurality of mounting surfaces and can include a display module that is configured to display images. The device can also have a sensor that can be configured to detect touches from one or more objects in relation to the images displayed by the display module and a cover that may sit over the sensor and the display module and can be in contact with the mounting surfaces. At least one of the mounting surfaces can include a gradient that may reach a peak away from an edge of the mounting surface such that the peak of the gradient forces the cover away from the display module.

As an example, each mounting surface may include two end sections and a middle, and the gradient and the peak of the gradient for each mounting surface may be substantially positioned at the middle of the mounting surface. As another example, the gradient may be a substantially smooth curved surface. The gradient may also force the sensor away from the display module.

A method of assembling an electronic device is also described herein. The method can include the steps of positioning a sensor over a display module, positioning a cover over the sensor and the display module and securing the cover to a frame having a perimeter with a plurality of mounting surfaces. One or more of the mounting surfaces may include a gradient such that the gradients force the cover into a convex position with respect to the display module.

In one arrangement, the gradients may also force the sensor into a convex position with respect to the display module, and the convex positioning of the sensor may substantially track the convex positioning of the cover. As an example, the gradients may be substantially smooth curved or angled surfaces. The method may also include the step of securing the cover to the sensor with a securing agent.

Further features and advantage, as well as the structure and operation of various embodiments, are described in detail below with reference to the accompanying drawings. It is noted that this description is not limited to the specific embodiments presented herein. Such embodiments are provided for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the subject matter described herein and, together with the description, further serve to explain the principles of such subject matter and to enable a person skilled in the relevant art(s) to make and use the subject matter.

FIG. 1 illustrates an example of an electronic device.

FIG. 2 illustrates an exploded view of a display stack and a frame.

FIG. 3 illustrates an example of an assembled display stack.

FIG. 4 illustrates an example of a side view of the electronic device of FIG. 1.

FIG. 5 illustrates another example of a side view of the electronic device of FIG. 1.

Applicants expressly disclaim any rights to any third-party trademarks or copyrighted images included in the figures. Such marks and images have been included for illustrative purposes only and constitute the sole property of their respective owners.

The features and advantages of the embodiments herein will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” “one arrangement,” “an arrangement” or the like, indicate that the embodiment or arrangement described may include a particular feature, structure, or characteristic, but every embodiment may not necessarily include the particular feature, structure, or characteristic. Moreover, such phrases are not necessarily referring to the same embodiment or arrangement. Furthermore, when a particular feature, structure, or characteristic is described in connection with an embodiment or arrangement, it is submitted that it is within the knowledge of one skilled in the art to implement such feature, structure, or characteristic in connection with other embodiments or arrangements whether or not explicitly described.

Several definitions that apply throughout this document will now be presented. The definitions listed here supersede any similar definitions that are presented in any previous related patent application. The term “exemplary” as used herein is defined as an example or an instance of an object, apparatus, system, entity, composition, method, step or process. The term “communicatively coupled” is defined as a state in which two or more components are connected such that communication signals are able to be exchanged between the components in a unidirectional or bidirectional (or multi-directional) manner, either wirelessly, through a wired connection or a combination of both. An “electronic device” is defined as a component that is configured to perform some process or function for a user and includes both mobile and non-mobile devices. A “frame” is defined as a component that provides at least physical support to one or more other components of an electronic device. The term “perimeter” is defined as a component that defines a boundary. An “image” is defined as a physical likeness or representation of an object, including symbols and text, displayed through a display module. A “cover” is defined as a substantially transparent component that provides protection to one or more other components.

The term “convex position” is defined as a position in which a surface of a component extends outward. The term “mounting surface” is defined as a surface that is configured to receive and provide support to one or more components. A “gradient” is defined as an inclined or upwardly curved surface, although not necessarily uniform in nature over its entire length. The term “securing agent” is defined as a component, substance or composition that is configured to secure two or more objects together, either permanently or temporarily.

As noted earlier, there is a drive to make portable devices as thin as possible. One way to help achieve this goal is by selecting a thin glass cover, which is typically positioned over a touch sensor and an LCD module. In doing so, however, the glass cover and, hence, the touch sensor may sag towards the LCD module. This effect may lead to the LCD module generating noise on the touch sensor, which is difficult to correct.

A solution is presented here to overcome these issues. In particular, an electronic device is described herein in which the device can include a frame that has a perimeter and can include a display module that may be configured to display images. The device can also have a sensor that may be configured to detect touches from one or more objects in relation to the images displayed by the display module. In addition, the device can have a cover that may sit over the sensor and the display module and can be in contact with at least a portion of the frame. In one embodiment, the perimeter of the frame can be configured to force at least a portion of the cover—and the sensor—into a convex position with respect to the display module.

As such, this arrangement may keep the sensor positioned a safe distance away from the display module, which can significantly reduce—if not eliminate—the interference from the noise from the display module. Moreover, because it may be forced into the convex position, the cover can remain relatively thin, which can help reduce the profile of the electronic device.

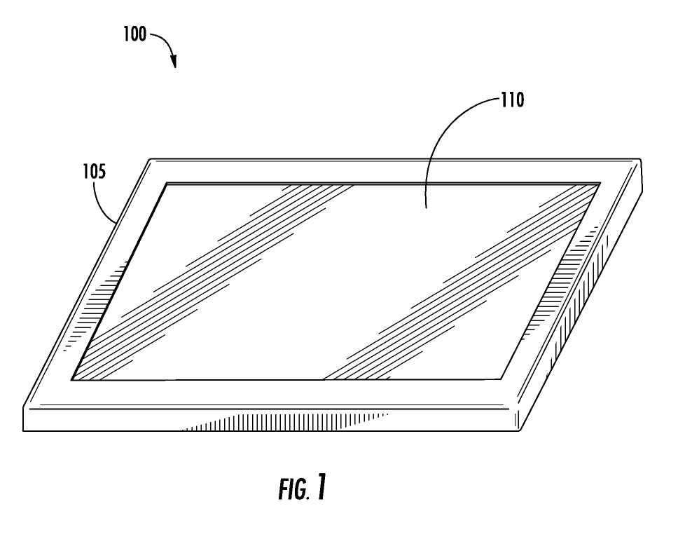

Referring to FIG. 1, an example of an electronic device 100 is shown. The device 100 can include a housing 105 and a display stack 110. The housing 105 may house and provide physical support for multiple components of the device 100. The display stack 110 may include a plurality of components that work together to enable images to the displayed to a user of the device 100. Additional details on both the housing 105 and the display stack 110 will be presented below.

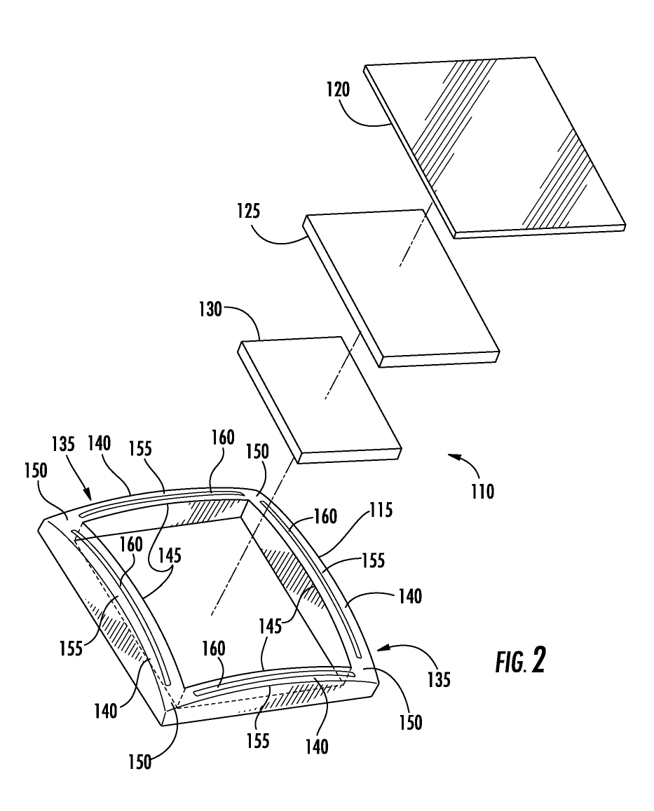

Referring to FIG. 2, an exploded view of the display stack 110 and a frame 115, which may form part of the housing 105, are shown. In one arrangement, the display stack 110 may include a cover 120, a sensor 125 and a display module 130, which may be configured to display images. The sensor 125 may be positioned over the display module 130, and the cover 120 may be positioned over the sensor 125 and the display module 130. As an example, the cover 120 may be constructed of glass or plastic, and the sensor 125 may be a touch sensor, which can be configured to detect touches from one or more objects in relation to the images displayed by the display module 130. Such objects may include, for example, a finger or a stylus.

In one arrangement, the sensor 125 may be constructed of glass or polyethylene terephthalate (PET) film or some other suitable plastic. Of course, the cover 120 and the sensor 125 may be made up of other suitable materials that are substantially transparent. Moreover, the sensor 125 is not necessarily limited to being a touch sensor, as any sensor that can detect certain stimuli can be employed here. For example, the sensor 125 may be a light sensor, a proximity sensor or even a sound sensor, which may receive corresponding inputs in relation to some image being displayed by the display module 130. In view of these possibilities, the sensor 125 is not limited to detecting objects that physically touch the cover 120, as the sensor 125 may be capable of detecting objects that do not physically touch the cover 120. As another example, the display module 130 may be an LCD module, although other types of displays may be used in the display stack 110.

As can be seen, the cover 120 and the sensor 125 may be separate parts, which can be secured to one another. It is important to note, however, that the cover 120 and the sensor 125 may be integrated into a single unit, in which case, a securing agent is not necessary.

In one particular non-limiting example, the cover 120 may be relatively thin, such as in the range of approximately 0.7 mm to approximately 1.0 mm, although other thicknesses may be selected. Additionally, the sensor 125 may be approximately 0.4 mm thick, while the display module 130 may be approximately 2.39 mm thick, although—like the cover 120—other thicknesses may be employed for these components.

The frame 115 may have a perimeter 135, which may or may not completely surround the frame 115. In one arrangement, the perimeter 135 may include one or more mounting surfaces 140. In this non-limiting example, the perimeter 135 may completely surround the frame 115, and the perimeter 135 may include four mounting surfaces 140, one for each side of the perimeter 135. Further, one or more of the mounting surfaces 140 may contain a gradient 145, which can result in the mounting surfaces being non-level, at least in certain areas. For example, a mounting surface 140 may include two end sections 150 and a middle section 155, and the gradient 145 may increase the height of the mounting surfaces 140 from the end sections 150 to the middle section 155.

As shown here, the gradient 145 can have a substantially smooth curved surface such that the slope of the gradient 145 starting at the end sections 150 is greater than that experienced in areas closer to the middle section 155. The gradient 145, however, may take on other forms. For example, the gradient 145 may have more of an angled surface in which the gradient 145 has a relatively consistent slope, which may lead to a point or flat surface at the middle section 155. As another example, the slope of the gradient 145 may be higher closer to the middle section 155 of the mounting surface 140, in comparison to that of the end sections 150. In one particular but non-limiting example, the gradient 145 may cause the height of the mounting surface 140 at the middle section 155 to be approximately 0.2 mm higher than the height of the surface 140 at the end sections 150. Of course, other heights may be realized here, and the heights at the end sections 150 may not necessarily be equal to one another.

In one arrangement, the mounting surfaces 140 may have a securing agent 160 positioned on them, which can be used to secure the cover 120 to the mounting surfaces 140 and, hence, the frame 115. As an example, the securing agent 160 may be very high bond (VHB) tape, although other suitable agents may be employed here. The securing agent 160 may be flexible, thereby allowing it to positioned on and substantially follow or match the contour of the gradient 145 of the mounting surfaces 140.

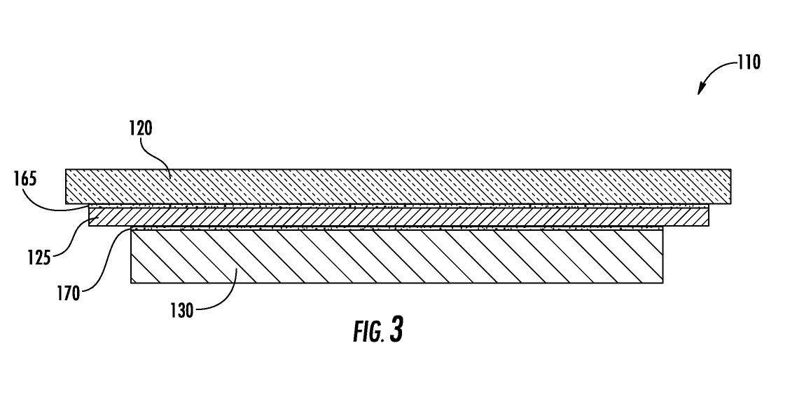

Referring to FIG. 3, an example of an assembled display stack 110 is shown. Here, the cover 120 is shown as a separate component with respect to the sensor 125, although, as previously mentioned, the cover 120 and the sensor 125 can be a single unit. In this example, the cover 120 can be secured to the sensor 125 with a securing agent 165, which may be, for example, an optical bonding agent or adhesive. The sensor 125 can also be secured to the display module 130 with a securing agent 170, which can be an optical bonding agent or adhesive. In one embodiment, the cover 120 may extend beyond the sensor 125 and the display module 130, which may be useful for securing the cover 120 to the frame 115, as will be discussed further below.

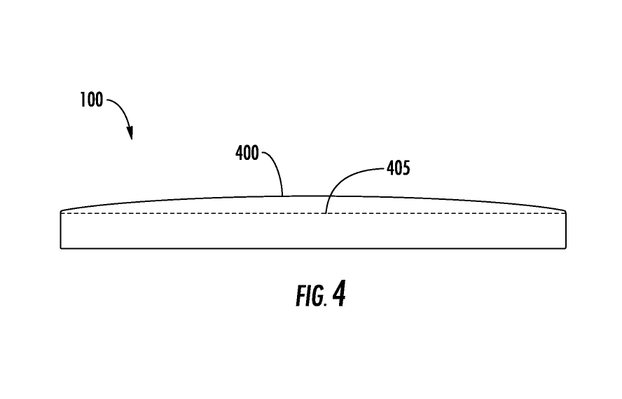

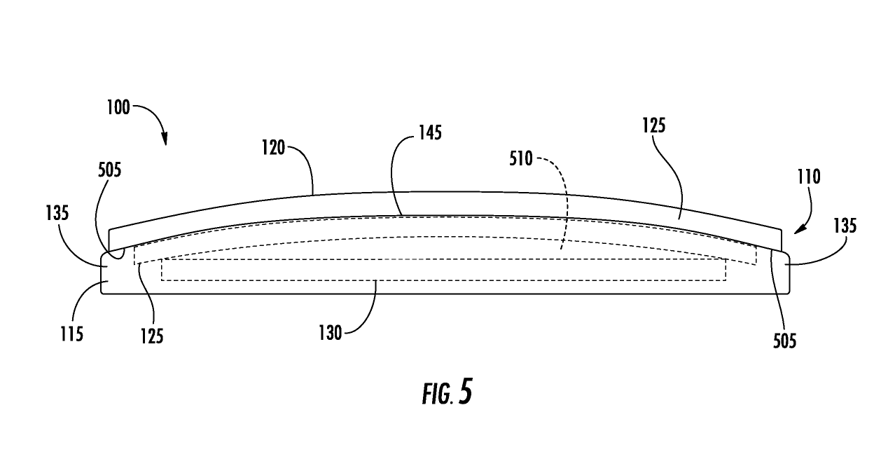

To keep the profile of the electronic device 100 to a relatively low height, the thickness of the cover 120 and the sensor 125 may be fairly thin. In prior art devices, these thin components would sag towards the display, which would result in degraded performance, as highlighted above. In view of the gradients 145 built into the frame 115, however, the cover 120 and possibly the sensor 125 may be forced into a convex position with respect to the display module 130. An example of this configuration is shown in FIGS. 4 and 5. In FIG. 4, a side view of the overall shape of an exemplary electronic device 100 constructed in accordance with the description herein is shown. As can be seen, a top surface 400 of the device 100 is shown rising outward, away from a dashed horizontal reference line 405 of the device 100. Although the convex positioning of the cover 120 and the sensor 125 may increase the overall height of the device 100, it is important to note that this difference is miniscule and allows for a much thinner cover 120 and/or sensor 125 without affecting the performance of the device 100.

Turning to FIG. 5, an illustration that builds on the exemplary device 100 of FIG. 4 is shown. In this illustration, the display stack 110 is shown as being secured to the frame 115. For example, the cover 120 of the stack 110 may be secured to the perimeter 135 of the frame 115. Because the cover 120 may extend beyond the outer edges of the sensor 125 and the display module 130 (shown in cross-hatching), a bottom surface 505 of the cover 120 may be secured to the perimeter 135, and the sensor 125 and display module 130 may float inside the frame 115, meaning that they have little to no contact with the frame 115. In other arrangements, the sensor 125, the display module 130 or both may be secured to the frame 115 for additional support, such as to the perimeter 135 or some other suitable portion of the frame 115.

As can be seen, based on the gradients 145 of the mounting surfaces 140, at least a portion of the cover 120 and the sensor 125 may be forced into a convex position with respect to the display module 130. That is, the gradient 145 (see FIG. 2) may reach a peak that is away from the end sections 150 of the mounting surfaces 140 such that the peak of the gradient 145 forces the cover 120 and the sensor 125 away from the display module 130. In one example, at least a portion of the convex positioning of the sensor 125 may substantially track the convex positioning of the cover 120, although such a configuration is not mandatory, as the cover 120 and the sensor 125 may have different convex positioning with respect to one another, using the display module 130 as a reference. It should also be noted that it is not necessary to include a cover 120 in the display stack 110, as the sensor 125 may be uncovered and placed in the convex position for optimal performance.

In view of the cover 120 and the sensor 125 assuming the convex positioning, a gap 510 may form between the sensor 125 and the display module 130. In one arrangement, the gap 510 may be filled with additional securing agent 170 or a void filled with air or some other gas/liquid may be formed. In fact, a shielding composition may be added to the securing agent 170 to further minimize any interference from the display module 130, if the composition does not seriously degrade the user's ability to view images from the display module 130.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

While various embodiments have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the claims and their equivalents should not be limited by any of the above-described exemplary embodiments.

What is claimed is:

1. An electronic device, comprising:
a frame that has a perimeter;
a display module that is configured to display images;
a sensor that is configured to detect touches from one or more objects in relation to the images displayed by the display module; and
a cover that sits over the sensor and the display module and is in contact with at least a portion of the frame;
wherein the perimeter of the frame is configured to force at least a portion of the cover into a convex position with respect to the display module.

2. The electronic device according to claim 1, wherein the perimeter of the frame includes one or more mounting surfaces and the mounting surfaces each contain a gradient.

3. The electronic device according to claim 2, wherein the mounting surfaces each have two end sections and a middle section and the gradient increases from the end sections towards the middle section.

4. The electronic device according to claim 3, wherein the gradient is a substantially smooth curved or angled surface.

5. The electronic device according to claim 2, further comprising a securing agent positioned on the mounting surfaces for securing the cover to the frame.

6. The electronic device according to claim 5, wherein the securing agent is positioned over the gradients of the mounting surfaces.

7. The electronic device according to claim 1, wherein the cover and the sensor are integrated into a single unit or are separate parts secured to one another with a securing agent.

8. The electronic device according to claim 1, wherein the perimeter of the frame forces at least a portion of the sensor into a convex position with respect to the display module.

9. The electronic device according to claim 8, wherein the convex positioning of the sensor substantially tracks the convex positioning of the cover.

10. The electronic device according to claim 1, wherein the display module is not in contact with the frame.

11. The electronic device according to claim 1, further comprising a securing agent that secures the display module to the sensor.

12. An electronic device, comprising:
a frame that has a perimeter;
a display module that is configured to display images;
a sensor that is configured to detect touches from one or more objects in relation to the images displayed by the display module; and
a cover that sits over the sensor and the display module;
wherein the perimeter of the frame is configured to force at least a portion of the cover and the sensor into a convex position with respect to the display module.

13. The electronic device according to claim 12, wherein the perimeter includes a plurality of mounting surfaces and each mounting surface includes a gradient.

14. The electronic device according to claim 13, wherein the gradient is a curved surface that corresponds to the convex position of the cover and the sensor.

15. The electronic device according to claim 12, wherein the cover and the sensor are integrated into a single unit or are separate parts secured to one another with a first securing agent.

16. The electronic device according to claim 13, further comprising a securing agent, wherein the securing agent is positioned on each of the mounting surfaces and secures the cover to the perimeter of the frame.

17. A method of assembling an electronic device, comprising:
positioning a sensor over a display module;
positioning a cover over the sensor and the display module; and
securing the cover to a frame having a perimeter with a plurality of mounting surfaces, wherein one or more of the mounting surfaces includes a gradient such that the gradients force the cover into a convex position with respect to the display module.

18. The method according to claim 21, wherein the gradients also force the sensor into a convex position with respect to the display module.

19. The method according to claim 22, wherein the convex positioning of the sensor substantially tracks the convex positioning of the cover.

20. The method according to claim 21, securing the cover to the sensor with a securing agent.
